(19) United States
(12) Patent Application Publication
(10) Pub. No.: US 2026/0189268 A1
(43) Pub. Date: Jul. 2, 2026

(54) COMMUNICATION METHOD BASED LOW EARTH ORBIT SATELLITE AND COMPUTING DEVICE FOR EXECUTING THE SAME

(71) Applicant: UNIVERSITY-INDUSTRY COOPERATION GROUP OF KYUNG HEE UNIVERSITY, Gyeonggi-do (KR)

(72) Inventors: CHOONG SEON HONG, Gyeonggi-do (KR); HASSAN SHEIKH SALMAN, Gyeonggi-do (KR); SEONG BAE PARK, Seoul (KR); YU MIN PARK, Gyeonggi-do (KR)

(21) Appl. No.: 19/130,251

(22) PCT Filed: Nov. 15, 2023
(86) PCT No.: PCT/KR2023/018373

§ 371 Date: May 15, 2025

(30) Foreign Application Priority Data
Nov. 15, 2022 (KR) 10-2022-0152733
Mar. 6, 2023 (KR) 10-2023-0029490

(51) Int. Cl. H04B 7/04; H04B 7/06; H04B 7/195; H04B 17/309

(52) U.S. Cl. CPC H04B 7/04013; H04B 7/0617; H04B 7/195; H04B 17/346

(57) ABSTRACT

A communication method of a communication system, which includes a plurality of satellites equipped with an RIS (Reconfigurable Intelligent Surface) panel, a plurality of rate user terminals, and at least one base station device, and is performed in a computing device equipped with one or more processors, and a memory storing one or more programs executed by the one or more processors, includes calculating a reception signal of a remote user terminal, when the remote user terminal receives a signal transmitted from a satellite, calculating a data rate of the remote user terminal using an SNR (Signal to Noise Ratio) of the corresponding user terminal for the reception signal, and optimizing pre-set parameters to maximize the data rate of the remote user terminal.

### SPONSORED RESEARCH AND DEVELOPMENT

National research and development program supporting this invention (1)
Project identification number: 1711194179
Project number: 00207816
Ministry name: Ministry of Science and ICT
Project management (specialized) institute name: National Research Foundation of Korea
Research program name: Group Research Support
Research project name: Meta Federated Learning-based Satellite-Air-Ground Integrated Networking System Core Structure Development
Contribution ratio: 1/5
Project performing agency name: Industry Academic Cooperation Foundation of Kyunghee University
Research period: 2023 Mar. 1-2024 Feb. 29
National research and development program supporting this invention (2)
Project identification number: 1711193491
Project number: 2019-0-01287-005
Ministry name: Ministry of Science and ICT
Project management (specialized) institute name: Institute of Information & Communications Technology Planning & Evaluation
Research program name: SW Computing Industry Source Technology Development
Research project name: (SW Starlab) Evolutionary Deep Learning Model Generation Platform for Distributed Edge
Contribution ratio: 1/5
Project performing agency name: Industry Academic Cooperation Foundation Of Kyunghee University
Research period: 2023 Jan. 1-2023 Dec. 31
National research and development program supporting this invention (3)
Project identification number: 1711193622
Project number: 2021-0-02068-003
Ministry name: Ministry of Science and ICT
Project management (specialized) institute name: Institute of Information & Communications Technology Planning & Evaluation
Research program name: Cultivating Innovative Professionals for Information and Communication Broadcasting
Research project name: Artificial Intelligence Innovative Hub Research and Development
Contribution ratio: 1/5
Project performing agency name: Korea University Research and Business Foundation
Research period: 2023 Jan. 1-2023 Dec. 31
National research and development program supporting this invention (4)
Project identification number: 1415186550
Project number: 20209810400030
Ministry name: Ministry of Trade, Industry and Energy
Project management (specialized) institute name: Korean Institute of Energy Technology Evaluation and Planning
Research program name: Energy New Technology Standardization and Certification Support Project
Research project name: Electric Vehicle PC-based Charging Service, Security authentication system establishment
Contribution ratio: 1/5
Project performing agency name: Korea Electrotechnology Research Institute
Research period: 2023 Jan. 1-2023 Apr. 30
National research and development program supporting this invention (5)
Project identification number: 1711198845
Project number: 00258649
Ministry name: Ministry of Science and ICT
Project management (specialized) institute name: Institute of Information & Communications Technology Planning & Evaluation
Research program name: Cultivating Innovative Professionals for Information and Communication Broadcasting
Research project name: Large AI Service Supporting Cloud Continuum Core Technology Development
Contribution ratio: 1/5
Project performing agency name: Industry Academic Cooperation Foundation Of Kyunghee University
Research period: 2023 Jul. 1-2023 Dec. 31

### BACKGROUND

### 1. Technical Field

Examples of the present invention are related to communication technology based on low Earth orbit satellite.

### 2. Background Art

Recently, the number of IoT devices has been rapidly increasing due to the development of IoT (Internet of Things). When the network of these IoT devices, the efficiency can be increased in various fields such as transportation, health, industry, energy, marine and the like, and the quality of life of people can be improved. However, internet access is still limited in certain areas of the world, and to solve this, a low Earth orbit (LEO) satellite network has been developed.

However, satellite communication resources for remote user equipment (RUE) are limited due to non-uniform geographical distribution and dynamic terrestrial traffic demand features, and in particular, there is a problem in that the signal transmission distance and coverage range of the low Earth orbit satellite are limited due to high radio wave attenuation, molecular absorption, and space loss in the subterahertz (Thz) frequency band. Therefore, a method to maximize the coverage of the low Earth orbit satellite and maximize the data transmission rate is required.

### SUMMARY

The examples of the present invention are to provide a communication method based on low Earth orbit satellite that can maximize a data rate for a remote user of a low Earth orbit satellite, and a computing device for performing the same.

The communication method according to one example disclosed, is a communication method of a communication system including a plurality of satellites equipped with an RIS (Reconfigurable Intelligent Surface) panel, a plurality of rate user terminals, and at least one base station device, and is a communication method performed in a computing device equipped with one or more processors, and a memory storing one or more programs executed by the one or more processors, and includes calculating a reception signal of a remote user terminal, when the remote user terminal receives a signal transmitted from a satellite; calculating a data rate of the remote user terminal using an SNR (Signal to Noise Ratio) of the corresponding user terminal for the reception signal; and optimizing pre-set parameters to maximize the data rate of the remote user terminal.

The reception signal (yᵤ) may be calculated by the following equation.

$${y}_{u} = \sqrt{\frac{{p}_{u}}{{L}^{tot}}} {g}_{u}^{T} {\prod }_{r = 1 , … , {R}_{s}} {Φ}_{r} {H}_{r} x + {z}_{u} \qquad ( Equation )$$

L^{tot}: Total loss until signals are received by a remote user terminal
pᵤ: Transmission power of a base station device
gᵤ: Channel from last RIS panel to the remote user terminal
x: Transmission vector of the base station device
Rₛ: Total number of RIS panels
zᵤ: AWGN (Additive White Gaussian Noise) received by the remote user terminal
r: Index of RIS
Hᵣ: Channel matrix between the base station device and RIS panel r
Φᵣ: Phase shift of the RIS panel r

The SNR (Signal to Noise Ratio) at time slot t (Γ_{u,t}) of the remote user terminal may be calculated by the following equation.

$${Γ}_{u , t} = \frac{{p}_{s , u} {\vert {v}_{b , u}^{s} {g}_{u}^{T} ( t ) {Π}_{r = 1 , … , {R}_{s}} {Φ}_{r} {H}_{r} ( t ) {w}_{u} \vert}^{2}}{{N}_{o} {L}^{tot} ( f , d )} \qquad ( Equation )$$

p_{s,u}: Power for transmitting signals from a satellite to the remote user terminal

$${v}_{b , u}^{s} :$$

Element of association matrix for the remote user terminal
N₀: Noise spectrum density
wᵤ: Beamforming vector of the base station device

The data rate (R_{u,t}) of the remote user terminal may be calculated by the following equation.

$${R}_{u , t} = {B}_{u} {log}_{2} ( 1 + {Γ}_{u , t} ) \qquad ( Equation )$$

Bᵤ: Total bandwidth available to the remote user terminal

The optimizing pre-set parameters, may optimize power (p) for transmitting a signal to a remote user terminal, an association matrix (V) between an RIS panel of a satellite and a remote user terminal, a phase shift (Φ) of the RIS panel of the satellite, and an elevation angle (α) of the satellite, to satisfy the objective function of the following equation.

$${max}_{p , V , Φ , α} {\sum }_{u = 1}^{U} {\sum }_{t = 1}^{T} {R}_{u , t} \qquad ( Equation )$$

The optimizing pre-set parameters, may include a first optimization step that optimizes the power (p) using a pre-set first algorithm after initiating the association matrix (v) between the RIS panel and remote user terminal, phase shift (Φ) of the RIS panel, and the elevation angle (α) of the satellite; and a second optimization step that optimizes the association matrix (V) between the RIS panel and remote user terminal, phase shift (Φ) of the RIS panel, and the elevation angle (α) of the satellite through a pre-set second algorithm based on the optimized power (p).

The first algorithm may be a WOA (Whale Optimization Algorithm), and the first optimization step, may calculate an optimal value of the power (p) through a fitness function by the following equation.

$$Fitness ( Φ ) = - {\sum }_{u = 1}^{U} {\sum }_{t = 1}^{T} \{ {R}_{u , t} ( Φ ) + μ {F}_{u , t} ( {f}_{u , t} ( Φ ) ) {f}_{u , t}^{2} ( Φ ) \} \qquad ( Equation )$$

ƒ_{u,t}(Φ): Inequality function
μ: Pre-set constant
F_{u,t}(ƒ_{u,t}(Φ)): Index function

The index function has a value of 0 when the inequality function is 0, and a value of 1 when the inequality function is less than 0.

The second algorithm may be an algorithm using a multi agent reinforcement learning model, and may optimize the association matrix (V) between the RIS panel and remote user terminal, phase shift (Φ) of the RIS panel, and the elevation angle (α) of the satellite to satisfy an objective function of the following equation.

$${max}_{V , Φ , α} {\sum }_{u = 1}^{U} {\sum }_{t = 1}^{T} {R}_{u , t} \qquad ( Equation )$$

The second optimization step, may include inputting the global state (s′) of the plurality of satellites and the local state (s′ₛ) of each satellite according to the following equation to the multi agent reinforcement learning model.

$$\begin{matrix}{s}^{′} = \{ \{ {d}_{1} \} , \{ {V}_{1} \} , \{ {Φ}_{1} \} , \{ {p}_{1}^{*} \} , \{ {i}_{1} , {ω}_{1} , {χ}_{1} \} \} , … , \{ {d}_{S} \} , \{ {V}_{S} \} , \{ {Φ}_{S} \} , \{ {p}_{S}^{*} \} , \{ {i}_{S} , {ω}_{S} , {χ}_{S} \} \} \\ {s}_{s}^{′} = \{ \{ {d}_{s} \} , \{ {V}_{s} \} , \{ {Φ}_{s} \} , \{ {p}_{s}^{*} \} , \{ {i}_{s} \} , \{ {ω}_{s} \} , \{ {χ}_{S} \} \}\end{matrix} \qquad ( Equation )$$

dₛ: Location of satellite s
Vₛ: Association matrix between the RIS panel and the user terminal of satellite s
Φₛ: Phase shift of the RIS panel of satellite s

$${p}_{s}^{*} :$$

Optimized power of satellite s
iₛ: Intersection angle between the orbital plane and equator of satellite s
ωₛ: Angle between the vernal equinox point and intersection point of orbital plane and equatorial plane of satellite s
χₛ: Angle formed by direction of the satellite and the intersection point of orbital plane and equatorial plane of satellite s

The second optimization step, may include calculating an action for an association between the RIS panel and user terminal, a phase shift of the RIS panel, and an elevation angle of the phase, based on the local state of each satellite in the multi agent reinforcement learning; and giving a global reward for the calculated action in the multi agent reinforcement learning model to the plurality of satellites.

The second optimization step, may further include learning the multi agent reinforcement learning model so that the global reward (R_{s′,t}) by the following equation is maximized.

$${R}_{{s}^{′} , t} = {R}_{t} ( {s}_{t}^{′} , {a}_{t} ) = \{ \begin{matrix}\begin{matrix}{\sum }_{u = 1}^{U} {\sum }_{t = 1}^{T} {R}_{u , t} , & if all the associated RUEs is served by networks ,\end{matrix} \\ \begin{matrix}- {Γ}^{pen} , & otherwise impose penalty to perform better in learning .\end{matrix}\end{matrix} \qquad ( Equation )$$

sₜ′: Local state of the satellite at time slot t
aₜ: Action of the satellite at time slot t
RUE: Remote user terminal
−Γ^{pen}: Penalty value

The computing device according to one example disclosed is a computing device for performing a communication method of a communication system including a plurality of satellites equipped with an RIS (Reconfigurable Intelligent Surface) panel, a plurality of rate user terminals, and at least one base station device, which includes one or more processors; a memory; and one or more programs, and is configured for the one or more programs to be stored in the memory, and be executed by the one or more processors, and the one or more programs, include an instruction for calculating a reception signal of a remote user terminal, when the remote user terminal receives a signal transmitted from a satellite; an instruction for calculating a data rate of the remote user terminal using an SNR (Signal to Noise Ratio) of the corresponding user terminal for the reception signal; and an instruction for optimizing pre-set parameters to maximize the data rate of the remote user terminal.

According to examples disclosed, by optimizing the power of the satellite, association matrix between the RIS panel of the satellite and remote user terminal, phase shift of the RIS panel of the satellite, and elevation angle of the satellite, the data rate according to the reception signal of the remote user terminal can be maximized, and the coverage of each low Earth orbit satellite can be optimized.

### BRIEF DESCRIPTION OF THE DRAWINGS

FIG. 1 is a diagram schematically showing the communication system using a low Earth orbit satellite according to one example of the present invention.

FIGS. 2A and 2B are diagrams schematically showing an angle of a low Earth orbit satellite to the center of the Earth used to control a coverage region in one example of the present invention.

FIG. 3 is a flow chart showing the process for maximizing a data rate of a remote user terminal in one example of the present invention.

FIG. 4 is a diagram showing a schematic diagram for multi agent reinforcement learning in one example.

FIG. 5 is a block diagram for illustrating and explaining a computing environment including a computing device suitable for use in exemplary examples.

### DETAILED DESCRIPTION

Hereinafter, specific embodiments of the present invention will be described with reference to drawings. The following detailed description is provided to help a comprehensive understanding of the method, device, and/or system described in the present description. However, these are only examples, and the present invention is not limited thereto.

In describing the example of the present invention, when it is judged that a detailed description of the prior art related to the present invention may unnecessarily obscure the gist of the present invention, the detailed description will be omitted. In addition, the terms described below are terms defined in consideration of functions in the present invention may vary depending on the intention or practice or the like of the user or operator. Therefore, the definition should be based on the contents throughout the present entire description. The terms used in the detailed description are intended to describe the examples of the present invention only, and should not be limited. Unless used otherwise clearly, singular expressions include meanings of plural expressions. In the present description, expressions such as “comprising” or “equipped” are intended to refer to certain features, numbers, steps, operations, elements, parts or combinations thereof, and they should not be construed to exclude the presence or possibility of one or more other features, numbers, steps, operations, elements, parts of combinations thereof, other than those described.

In the following description, the terms “sending”, “communication”, “transmission”, “receiving” and other terms with similar meanings thereto of signals or information include not only directly transmitting signals or information from one component to another component, but also transmitting via another component. In particular, “sending” or “transmitting” signals or information to one component indicates the final destination of the signals or information, and does not mean the direct destination. This is same even in “receiving” of signals or information. In addition, in the present invention, that two or more data or information is “related” means that at least some of other data (or information) can be obtained based on it, when one data (or information) is obtained.

In addition, the terms of the first, the second, and the like can be used to describe various components, but the components should not be limited by the terms. The terms may be used for the purpose of distinguishing one component from other components. For example, without departing from the scope of the present invention, the first component may be named the second component, and similarly, the second component may also be named the first component.

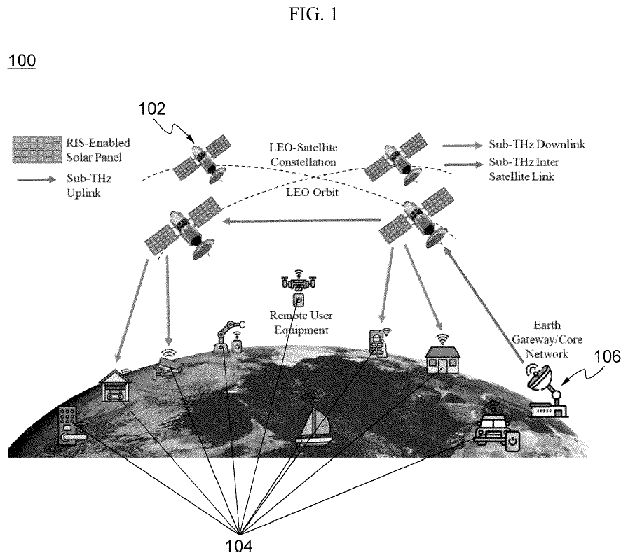

FIG. 1 is a diagram schematically showing the communication system using a low Earth orbit satellite according to one example of the present invention.

Referring to FIG. 1, the communication system (100) using a low Earth orbit satellite may include a satellite (102), a remote user terminal (104) and a base station device (106).

A plurality of satellites (102) is prepared. The satellites may be low Earth orbit (LEO) satellites. Each satellite (102) may be arranged at the optimal location to provide global coverage. The communication system (100) may include a minimal number of satellites (102) that provide global coverage and satisfy pre-set requirements.

Each satellite (102) may be associated with all remote user terminals (104) of the corresponding coverage area. In addition, each remote user terminal (104) may be used by uniformly dividing the bandwidth available in the subhertz band of each satellite (102).

In the satellite (102), an RIS (Reconfigurable Intelligent Surface) panel may be prepared. The RIS panel may be referred to as an intelligent reflecting surface. In other words, in the satellite (102), the RIS panel which can control a phase shift and increase signal intensity may be installed. The RIS panel can be programmed to change electromagnetic fields to focus, adjust and enhance signal power for a target user.

In the example disclosed, by installing the RIS panel to the satellite (102), the satellite coverage may be maximized. This can be implemented by adjusting a phase shift of the RIS panel. The RIS panel may be configured by meta surfaces capable of changing the reflecting phase. Then, beamforming may be achieved for the target user by adjusting the phase shift in the RIS panel. In the satellite (102), the RIS panel may be arranged in the bottom of a solar panel.

Each RIS panel r may be composed of a matrix including n reflecting elements Nᵣ. In each reflecting element, a phase shifter capable of reconstructing an incident signal to prevent radio wave loss. The remote user terminal (104) may use various kinds of communication services through the satellite (102). The remote user terminal (104) may use various heterogenous instruments. The remote user terminal (104) may be located in various places and equipment such as a home, office, ship, aircraft, vehicle, or the like, but may also be a device carried by each individual.

The base station device (106) may control arrangement of the satellite (102). The base station device (106) may be prepared to optimize the phase shift, phase transmission power, and beamforming and the like of downlink communication through the satellite (102). The base station device (106) may implement this through scheduling policies, transmission power allocation, phase shift control, and phase elevation angle adjustment for maximizing the coverage of each satellite (102). Then, each satellite (102) may play a role of a kind of distribution agent, and may be controlled by the base station device (106) centrally. Detailed description for this will be described later. Through this optimization, the base station device (106) can maximize the average data rate for the remoter user terminal (104) of the satellite (102).

The communication system (100) may be a satellite-based multiple input multiple output (MIMO) system. The communication system (100) may be prepared to minimize radio wave attenuation in the subterahertz (Sub-Thz) band for the remote user terminal (104). The communication system (100) may provide a high-speed data service for the remote user terminal (104) which is not under coverage of terrestrial network infrastructure. In addition, a wireless service may be provided by satisfying demands that cannot be satisfied by the conventional terrestrial network also in the city area.

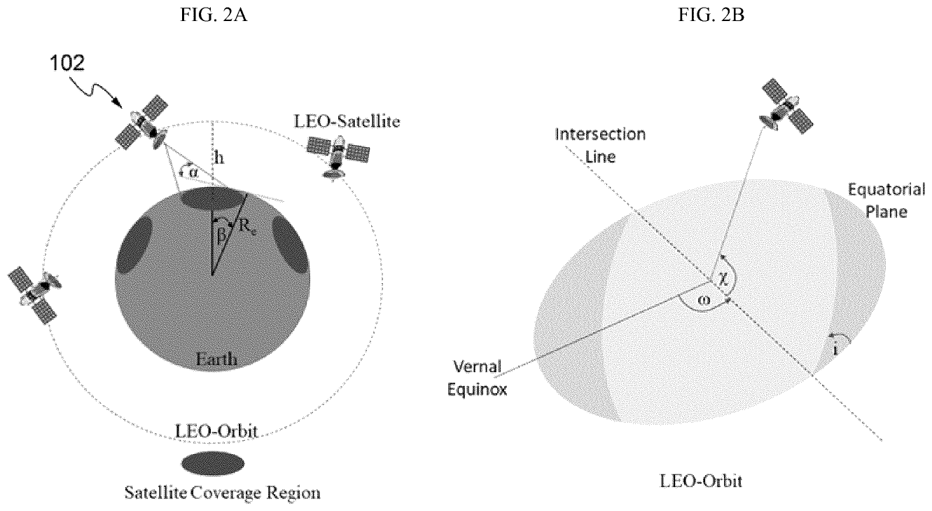

FIGS. 2A and 2B are diagrams schematically showing an angle of a low Earth orbit satellite to the center of the Earth used to control a coverage region in one example of the present invention.

Referring to FIGS. 2A and 2B, the orbit of each satellite(s) may be assumed to be circular. The three-dimensional position of the satellite. (s) at time t slot may be expressed as dₛ(t)=[(xₛ(t), [symbol] (t), zₛ(t))]^{T}. In addition, the position at the next time slot of the satellite(s) in a specific orbit m may be expressed as

$${d}_{s}^{m} ( t + 1 ) = {d}_{s}^{m} ( t ) + {υ}_{s} {Δ}_{T} .$$

Herein, Δ_{T} may be an interval between slots at each time, and vₛ may be a rate of a satellite.

On the other hand, to coordinate the direction and location of the satellite to the equator, the following three angles (equator-related satellite angles) may be used. 1) The first angle, inclined angle i, may be defined as an intersection angle between the orbit plane and the equator. An inclined angle greater than 90 degrees indicates that the satellite movement is opposite to the direction of the Earth's rotation. 2) The second angle, angle ω, may be defined as an angle between the vernal equinox point and intersection point of orbital plane and equatorial plane of satellite. 3) The third angle, angle χ, may be defined as an angle formed by direction of satellite and intersection point of orbital plane and equatorial plane of satellite.

Cartesian coordinates (xₛ(t), [symbol] (t), zₛ(t)) at a time 5 slot of each satellite(s) with the center of the Earth as the origin may be expressed by the following Equation 1.

$$\begin{matrix}\begin{matrix}{x}_{s} ( t ) = ( {h}_{s} + {R}_{e} ) [ cos χ ( t ) cos ω ( t ) - sin χ ( t ) cos i ( t ) sin ω ( t ) ] , & ∀ s ∈ {𝒮}_{m} ,\end{matrix} \\ \begin{matrix}{y}_{s} ( t ) = ( {h}_{s} + {R}_{e} ) [ cos χ ( t ) sin ω ( t ) - sin χ ( t ) cos i ( t ) cos ω ( t ) ] , & ∀ s ∈ {𝒮}_{m} ,\end{matrix} \\ \begin{matrix}{z}_{s} ( t ) = ( {h}_{s} + {R}_{e} ) [ sin χ ( t ) sin i ( t ) ] , & ∀ s ∈ {𝒮}_{m} ,\end{matrix}\end{matrix} \qquad ( Equation 1 )$$

hₛ: Altitude of satellite
Rₑ: Earth's radius
Sₘ: Set of satellites arranged in orbital plane m

Herein, the distance between two satellites (s, s′) may be calculated by the following Equation 2.

$${d}_{s , {s}^{′}} = \sqrt{{( {R}_{e} + {h}_{s} )}^{2} + {( {R}_{e} + {h}_{{s}^{′}} )}^{2} - 2 ( {R}_{e} + {h}_{s} ) ( {R}_{e} + {h}_{{s}^{′}} ) cos δ} \qquad ( Equation 2 )$$

δ: Angle between two satellites in one orbital as seen from the center of the Earth

The angle δ between two satellites (s, s′) may be expressed as δ=|αₛ=α_{s′}|, and α is an elevation angle of each satellite.

In addition, the distance (d_{b,s}) between the base station device (b) and satellite(s) at time t slot may be expressed by the following Equation 3, and the distance (d_{s,u}) between the satellite(s) and the remote user terminal (u) at time t slot may be expressed by the following Equation 4.

$${d}_{b , s} = \sqrt{{R}_{e}^{2} {sin}^{2} {α}_{b} + {h}_{s}^{2} + 2 {h}_{s} {R}_{e}} - {R}_{e} sin {α}_{b} \qquad ( Equation 3 )$$

$${d}_{s , u} = \sqrt{{R}_{e}^{2} {sin}^{2} {α}_{u} + {h}_{s}^{2} + 2 {h}_{s} {R}_{e}} - {R}_{e} sin {α}_{u} \qquad ( Equation 4 )$$

Furthermore, the elevation angle between the base station device (b) and satellite(s) at time t slot may be expressed by the following Equation 5, and the elevation angle between the satellite(s) and remote user terminal (u) at time t slot may be expressed by the following Equation 6.

$${α}_{b , s} ( t ) = arc cos ( \frac{{R}_{e}^{2} + {d}_{b , s} ( t ) - {( {R}_{e} + h )}^{2}}{2 {R}_{e} {d}_{b , s} ( t )} ) - \frac{π}{2} \qquad ( Equation 5 )$$

$${α}_{s , u} ( t ) = arc cos ( \frac{{R}_{e}^{2} + {d}_{s , u} ( t ) - {( {R}_{e} + h )}^{2}}{2 {R}_{e} {d}_{s , u} ( t )} ) - \frac{π}{2} \qquad ( Equation 6 )$$

Herein, the Line-of-Sight (LoS) radio wave distance and the minimal elevation angle of the base station device (b) and remote user terminal (u) may determine a coverage region provided by the satellite(s). At this time, as the minimal elevation angle becomes bigger, the coverage of the satellite becomes smaller.

In the communication system (100), indirect communication links include satellite-to-base station device links, satellite-to-satellite links, and satellite-to-remote user terminal links. Herein, each link shares the same function, so the same channel model may be used. In addition, in the subterahertz band, the signal radio wave is affected by spreading loss, molecular absorption loss near the Earth, loss due to rain and clouds, and ionospheric plasma loss and the like.

The spreading loss may refer to a proportion of power emitted by an isotropic transmitter that can be detected by an isotropic receiver. The molecular absorption loss may indicate a proportion of electromagnetic energy converted into kinetic energy in vibrating molecules. The loss due to rain and clouds may mean loss according to scattering and absorption by rain and clouds, when signals moves through the atmosphere. The ionospheric plasma loss may mean loss occurring when signals pass through the plasma of the ionosphere.

Herein, total loss occurring when a signal with frequency f is propagated by a distance d may be expressed by the following Equation 7.

$${L}^{tot} ( f , d ) = \frac{{( 4 π d f )}^{2} {L}^{ab s} ( f , d ) {L}^{rain} {L}^{cloud} {L}^{atten}}{{c}^{2} {G}_{b} {G}_{u} {d}_{x} {d}_{y} {A}^{α} {\vert {\sum }_{{n}_{s} = 1}^{{N}_{r}} \frac{\sqrt{{F}_{{n}_{s}}^{tot}}}{{d}_{b , s} {d}_{s , {s}^{′}} {d}_{s , u}} \vert}^{α}} \qquad ( Equation 7 )$$

L^{abs}: Molecular absorption loss
L^{rain}: Loss due to rain
L^{cloud}: Loss due to clouds
L^{atten}: Attenuation coefficient (Loss per unit distance depending on signal propagation path)
c: Speed of light
G_{b}: Antenna gain of the base station device
Gᵤ: Antenna gain of the remote user terminal
dₓ, d_{y}: Size of x direction and y direction of a unit cell of the satellite
A: Satellite coverage
α: Elevation angle of the satellite
d_{b,s}: Distance between the satellite and base station device
d_{s,s′}: Distance between the satellite and another satellite
d_{s,u}: Distance between the satellite and remote user terminal
Nᵣ: Number of reflecting elements of the RIS panel
nₛ: sₜₕ reflecting element of the RIS panel

$${F}_{{n}_{s}}^{tot} :$$

Normalized total radiation pattern considered in received signal power

On the other hand, in the base station device (106), a plurality of (K) antennas performing communication with a plurality of remote user terminals in an exclusive area may be installed. The base station device (106) may transmit data streams from the K antennas simultaneously by supporting various RIS panels to the remote user terminal (102) to improve the coverage range of the subterahertz communication. When the RIS panel is activated, each data stream may be beamformed to one remote user terminal (102).

Herein, if H₁∈ [symbol] is defined as a channel matrix between the base station device and RIS of the first satellite, and Hᵣ₊₁ ∈ [symbol] is defined as a channel matrix between RIS r and RIS r+1, the signal (yᵤ) received from the remote user terminal (u) may be expressed by the following Equation 8. At this time, the signal transmitted from the base station device (b) may be assumed to move by passing through an RIS hop Rₛ (Rₛ≤S, S is total number of satellites) before reaching the remote user terminal (u). In other words, Rₛ may refer to an RIS panel through which the signal passes before reaching the remote user terminal.

$${y}_{u} = \sqrt{\frac{{p}_{u}}{{L}^{tot}}} {g}_{u}^{T} {\prod }_{r = 1 , … , {R}_{s}} {Φ}_{r} {H}_{r} x + {𝓏}_{u} \qquad ( Equation 8 )$$

L^{tot}: Total loss until signals are received by the remote user terminal

pᵤ: Transmission power of the base station device
gᵤ: Channel from last RIS panel to the remote user terminal
x: Transmission vector of the base station device
zᵤ: AWGN (Additive White Gaussian Noise) received by the remote user terminal
r: Index of RIS
Hᵣ: Channel matrix between the base station device and RIS r
Φᵣ: Phase shift of RIS r

Herein, the phase shift (Φᵣ) of the rₜₕ RIS panel may be expressed by the following Equation 9.

$${Φ}_{r} {=}^{Δ} diag [ {A}_{r 1} {e}^{j {θ}_{r 1}} , {A}_{r 2} {e}^{j {θ}_{r 2}} , … , {A}_{{rn}_{r}} {e}^{j {θ}_{r {n}_{r}}} ] \qquad ( Equation 9 )$$

Aᵣₙ: Amplitude of the nth element in the rₜₕ RIS panel
θᵣₙ: Reflecting coefficient of the nth element in the rₜₕ RIS panel

In addition, the association matrix for all R RIS panels and all U remote user terminals may be expressed as V∈ [symbol] . The element of the association matrix V for each remote user terminal (u) may be expressed by the following Equation 10.

$${υ}_{b , u}^{s} = \{ \begin{matrix}1 , & if GBS b transmits to RUE u via {s}^{th} satellite \\ 0 , & otherwise .\end{matrix} \qquad ( Equation 10 )$$

GBS: Base station device
RUE: Remote user terminal

Furthermore, the transmission vector (x) may be expressed as

$$x {=}^{Δ} {\sum }_{u = 1}^{U} {w}_{u} {s}_{u} .$$

Herein, wᵤ∈ [symbol] (K is the number of antennas of the base station device) may be a beamforming vector, and sᵢ∈ [symbol] (0, 1) may be a Gaussian signal of each remote user terminal (u).

The instant SNR (Signal to Noise Ratio) of the remote user terminal (u) at each time slot t for the reception signal given by Equation 8 may be expressed by the following Equation 11.

$${Γ}_{u , t} = \frac{{p}_{s , u} {\vert {υ}_{b , u}^{s} {g}_{u}^{T} ( t ) {\prod }_{r = 1 , … , {R}_{s}} {Φ}_{r} {H}_{r} ( t ) {ω}_{u} \vert}^{2}}{{N}_{o} {L}^{tot} ( f , d )} \qquad ( Equation 11 )$$

p_{s,u}: Power for transmitting signals from satellite to the remote user terminal
N₀: Noise spectrum density

In addition, the executable data rate (R_{u,t}) of the remote user terminal (u) at time slot t may be expressed by the following Equation 12.

$${R}_{u , t} = {B}_{u} {log}_{2} ( 1 + {Γ}_{u , t} ) \qquad ( Equation 12 )$$

Bᵤ: Total bandwidth available to remote user terminal

Thus, increasing the RIS panel and SNR level can improve the data rate.

In the communication system (100), by optimizing the association between the RIS panel and remote user terminal, phase shift, satellite power, and elevation angle in the pre-set limited conditions, the data rate of the remote user terminal (102) can be maximized. According to this, the objective function of the communication system (100) may be expressed by the following Equation 13.

$${max}_{p , V , Φ , α} {\sum }_{u = 1}^{U} {\sum }_{t = 1}^{T} {R}_{u , t} \qquad ( Equation 13 )$$

p: Power for transmitting signals to the remote user terminal in the satellite
V: Association matrix between the RIS panel of the satellite and the remote user terminal
Φ: Phase shift of the RIS panel of the satellite
α: Elevation angle of the satellite

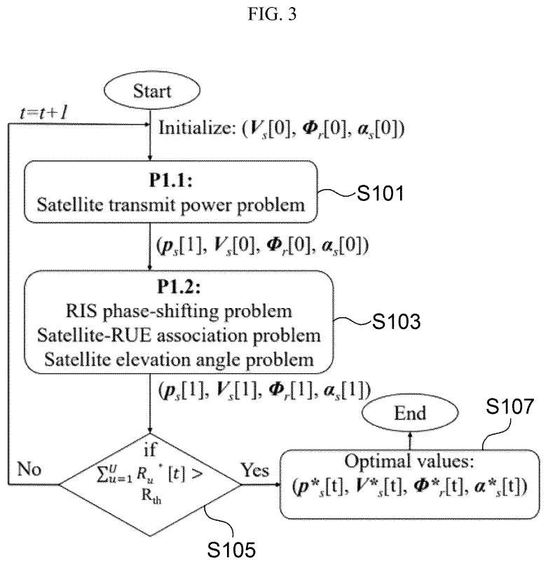

FIG. 3 is a flow chart showing the process for maximizing a data rate of a remote user terminal in one example of the present invention. Referring to FIG. 3, the problem of maximizing the data rate of the remote user terminal may be largely divided into 2. First, the power of the satellite can be optimized by initiating the association matrix, phase shift, and elevation angle (S101), and then the association matrix, phase shift, and elevation angle can be optimized based on the optimized power of the satellite (S 103). Then, by confirming whether the date rate of the remote user terminal is maximized (S 105), the optimized values of the satellite power, association matrix, phase shift, and elevation angle can be output, if the data rate is maximized (S 107). If the data rate is not maximized, the above process may be repeated.

Specifically, the problem of maximizing the transmission power of the satellite can be solved using a WOA (Whale Optimization Algorithm). When the association matrix (v) between the RIS panel and remote user terminal, phase shift (Φ) of the RIS panel, and elevation angle (α) of the satellite are initiated, the problem of maximizing the transmission power of the satellite may be expressed as the following Equation 14.

$${max}_{p} {\sum }_{u = 1}^{U} {\sum }_{t = 1}^{T} {R}_{u , t} ( p ) \qquad ( Equation 14 )$$

Herein, the whale optimization algorithm (WOA) is a meta-heuristic algorithm that mimics hunting characteristics of humpback whales. After finding prey, the humpback whales dive deep beneath the prey and create spiral bubbles, and these bubbles play a role of encircle the prey in a smaller range.

In the WOA, each whale (agent) represents control variables different from each other, and the distance between the whale and prey means the cost of the objective function. Then, the location by time of each whale is calculated through the processes of 1) encircling prey, 2) bubble-net attacking, and 3) search for prey. The whale optimization algorithm (WOA) is a well-known algorithm, and detailed description for this will be omitted.

In the example disclosed, the power (p) of the satellite may be the location of the whale. The optimal whale location (i.e. power value of satellite) may be calculated by a fitness function by the following Equation 15.

$$Fitness ( Φ ) = - {\sum }_{u = 1}^{U} {\sum }_{t = 1}^{T} \{ {R}_{u , t} ( Φ ) + μ {F}_{u , t} ( {f}_{u , t} ( Φ ) ) {f}_{u , t}^{2} ( Φ ) \} \qquad ( Equation 15 )$$

ƒ_{u,t}(Φ): Inequality function
μ: Pre-set constant
F_{u,t}(ƒ_{u,t}(Φ)): Index function

Herein, the index function F_{u,t}(ƒ_{u,t}(Φ)) may have a value of 0 when the inequality function ƒ_{u,t}(Φ) is 0 or more, and have a value of 1 when the inequality function ƒ_{u,t}(Φ) is less than 0. In other words, the correlation of the index function and inequality function may be expressed by the following Equation 16.

$${F}_{u , t} ( {f}_{u , t} ( Φ ) ) = 0 if {f}_{u , t} ( Φ ) \geq 0 \qquad ( Equation 16 )$$

$${F}_{u , t} ( {f}_{u , t} ( Φ ) ) = 1 if {f}_{u , t} ( Φ ) < 0$$

Marking a negative sign on the right side of the fitness function of Equation 15 is to convert the problem of maximizing into the problem of minimizing.

As such, when the power (p) of the satellite is optimized, the communication system (100) may optimize the association (V) between the RIS panel and remote user terminal, phase shift of the RIS panel, and elevation angle (α) of the satellite through multi agent reinforcement learning. This may be expressed by the following Equation 17.

$${max}_{V , Φ , α} {\sum }_{u = 1}^{U} {\sum }_{t = 1}^{T} {R}_{u , t} \qquad ( Equation 17 )$$

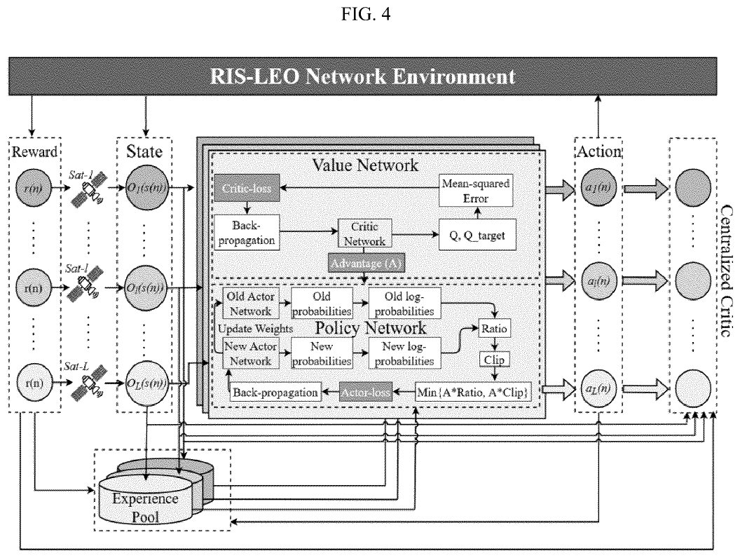

FIG. 4 is a diagram showing a schematic diagram for multi agent reinforcement learning in one example. Referring to FIG. 4, the RIS-LEO network environment may include total network environments including all information of the low earth orbit satellite, used power, input and output signals of RIS, and amplitude and angle of the satellite. At this time, the information in the network may be used for jointly learning each low earth orbit satellite (agent). Each agent may receive observation of status from the network environment. Herein, each satellite plays a role of the agent. The multi agent reinforcement learning model may be installed in the base station device, but not limited thereto, and may be installed in other server computing device.

The multi agent reinforcement model may have a policy network θₛ and a value network σₛ. Herein, the policy network and value network may be artificial neural networks for multi agent reinforcement learning. The value network may play a local critic role of each agent. The value network can provide an immediate feedback for its accuracy, when each agent (satellite) learns a new policy. The policy network may play a learning unit role of a major policy. The policy may be used for making decisions (i.e. actions) in each agent.

The action taken dispersively by each agent may be used for evaluation by a centralized critic. The centralized critic may ensure cooperation between all agents, and calculate global loss of all agents, and ensure that the performance of the system converges globally. In order to analyze the results of each distributed agent, a current reward may be sent to the centralized critic, and each reward and state may be stored in the Experience Pool.

The policy network may be referred to as an actor, and the value networks may be referred to as a critic. The policy network (i.e. actor) may see only the local information (i.e. information about the corresponding agent) and generate an action based on this, but the value network (i.e. critic) may see total information of other agents (i.e. other satellites) to optimize itself better.

Herein, if the global state is s′, and the local state of the agent s (i.e. satellite s) is s's, this may be expressed by the following Equation 18. The local states (i.e. global state) of each agent are used as inputs of the reinforcement learning model.

$$( Equation 18 )$$

$${s}^{′} = \{ \{ {d}_{1} \} , \{ {V}_{1} \} , \{ {Φ}_{1} \} , \{ {p}_{1}^{*} \} , \{ {i}_{1} , {ω}_{1} , {χ}_{1} \} \} , \text{} … , \{ {d}_{S} \} , \{ {V}_{S} \} , \{ {Φ}_{S} \} , \{ {p}_{S}^{*} \} , \{ {i}_{S} , {ω}_{S} , {χ}_{S} \} \}$$

$${s}_{s}^{′} = \{ \{ {d}_{s} \} , \{ {V}_{s} \} , \{ {Φ}_{s} \} , \{ {p}_{s}^{*} \} , \{ {i}_{s} \} , \{ {ω}_{s} \} , \{ {χ}_{s} \} \}$$

dₛ: Location of satellite s
Vₛ: Association matrix between the RIS panel and the user terminal of satellite s
Φₛ: Phase shift of the RIS panel of the satellite s

$${p}_{s}^{*} :$$

Optimized power of the satellite s
iₛ: Intersection angle between the orbital plane and equator of the satellite s
ωₛ: Angle between the vernal equinox point and intersection point of orbital plane and equatorial plane of the satellite s
χₛ: Angle formed by direction of the satellite and the intersection point of orbital plane and equatorial plane of satellite s The agent s may deliver the local state s′ₛ into the actor (policy network), after obtaining the optimal power

$$\{ {p}_{s}^{*} \}$$

in the area of responsibility. In the local state s′ₛ, the actor may calculate a method for optimizing the association between the RIS panel and remote user terminal, phase shift of the RIS panel, and elevation angle of the satellite. At this time, the action (as) performed by the actor of the agent may be expressed by the following Equation 19. In other words, the agent (satellite) may take an action to change one or more of the association between the RIS panel and remote user terminal, phase shift of the RIS panel and elevation angle of the satellite.

$${a}_{{s}^{′}} = \{ \{ {α}_{{s}^{′}} \} , \{ {V}_{{s}^{′}} \} , \{ {ϕ}_{{s}^{′}} \} \} \qquad ( Equation 19 )$$

After generating an action probability, the actor may sample action distribution and interact with the local environment, and obtain a reward (Rₛ) before moving to the next state

$$( {\tilde{s}}_{s}^{′} ) .$$

In addition, in the experience pool, experience

$$( {s}_{s}^{′} , {a}_{s} , {R}_{s} , {\tilde{s}}_{s}^{′} )$$

is saved. At this time, the data throughput and QoS fairness to maximize Equation may be used as immediate rewards. In addition, in order to reinforce cooperation of agents, they may receive a global reward represented by Equation 20.

$$( Equation 20 )$$

$${R}_{{s}^{′} , t} = {R}_{t} ( {s}_{t}^{′} , {a}_{t} ) = \{ \begin{matrix}{\sum }_{u = 1}^{U} {\sum }_{t = 1}^{T} {R}_{u , t} , if all the associated RUEs is served by networks , \\ - {Γ}^{pen} , otherwise impose penalty to perform better in learning\end{matrix} .$$

−Γ^{pen}: Penalty value

Herein, the global reward Ret is an immediate reward of the agent s′. All agents (all satellites) may share the global reward. The reinforcement learning model may be learned to maximize the global reward.

A cumulative discounted reward may be calculated by Equation 21 using a discount rate γ (a value between 0 to 1).

$$R ( t ) = {\sum }_{k = 0}^{∞} {γ}^{A} {R}_{{s}^{′} , t} ( t + k + 1 ) \qquad ( Equation 21 )$$

If a combined policy of multi agents is π={πₛ|s∈ [symbol] }, a state-value function (V^{π}) may expressed by Equation 22.

$${V}^{π} ( {s}^{′} ( t ) ) = {𝔼}_{a ( t ) , {s}^{′} ( t + 1 )} , … [ R ( t ) \vert {s}^{′} ( t ) ] \qquad ( Equation 22 )$$

Herein, the problem of optimizing may be applied as determining the best method for maximizing the predicted cumulative discounted reward for the initial state s′(0), and therefore, the problem of optimizing of Equation 17 through multi agent reinforcement learning may be expressed by the following Equation 23. In other words, the problem of optimizing of Equation 17 may be represented by searching an optimal policy to maximize the predicted cumulative reward over time.

$$\begin{matrix}{π}^{*} = arg max {𝔼}_{{s}^{′} ( 0 ) \sim {ρ}_{s} ( {s}^{′} ( 0 ) )} [ {V}^{π} ( {s}^{′} ( 0 ) ) ] \\ = arg max κ ( π )\end{matrix} . \qquad ( Equation 23 )$$

On the other hand, maximizing κ(π) with given π^{old} is same as maximizing the following Equation 24.

$${𝔼}_{π} [ {A}^{{π}^{old}} ( {s}^{′} ( t ) , a ( t ) ) ] \qquad ( Equation 24 )$$

A^{π}(s′(t), a(t)): Advantage function

Herein, the advantage functions is as A^{π}(s′(t), a(t)={Q^{π}(s′(t), a(t))−V^{π}(s′(t))}. In addition, Q^{π}(s′(t), a(t)) is a state-action value functions, and this may be expressed by Q^{π}(s′(t), a(t))= [symbol] _{a(t+1),s′(t+1)}, . . . [R(t)|(s′(t), a(t))]. Moreover, when [symbol] _{π}[A^{π}^{^{old}}(s′(t), a(t))] is approximated using a clip function, the problem of optimizing of Equation 23 may be converted as the following Equation 25.

$${max}_{θ = \{ {θ}_{s} \vert s ∈ S \}} {𝔼}_{{π}^{old}} \{ min [ {r}^{′} ( {θ}_{s} ) {A}^{{π}^{old}} ( {s}^{′} ( t ) , a ( t ) ) , clip ( {r}^{′} ( {θ}_{s} ) , ϵ ) {A}^{{π}^{old}} ( {s}^{′} ( t ) , a ( t ) ) ] \} \qquad ( Equation 25 )$$

r′(θ): Joint probability ratio

Herein, the joint probability ratio may be expressed by

$${r}^{′} ( θ ) = \frac{{π}_{s} ( a \vert {s}^{′} ; θ )}{{π}_{s}^{old} ( a \vert {s}^{′} ; {θ}^{old} )} .$$

The value of the joint probability ratio may be maintained in the range of [1−ϵ₁, 1+ϵ₁] using a clip function of maintaining the policy update in a small range.

As the joint action of all agents except for the agent s, a^{-s} may be used, and as the integrated policy of all agents except for the agent s, π^{-s} may be used. Since policies are independent, it is safe to believe that

$$π ( a \vert τ ) = {Π}_{s = 1}^{S} {π}^{s} ( {a}^{s} \vert {τ}^{s} ) .$$

Herein, τ is an action-observation history. From this factorization, a target as the following Equation 26 may be generated.

$${max}_{{θ}^{1} , … , {θ}^{S}} {𝔼}_{a \sim {π}_{old}} \{ min [ ( {\prod }_{s = 1}^{S} {r}_{s}^{′} ) {A}^{π} , clip ( ( {\prod }_{s = 1}^{S} {r}_{s}^{′} ) , 1 - ϵ , 1 + ϵ ) {A}^{π} ] \} \qquad ( Equation 26 )$$

θ^{s}: Policy parameter of agent s

Herein, it is that

$${r}_{s} = \frac{{π}^{s} ( {a}^{s} \vert {τ}^{s} ; {θ}^{s} )}{{π}_{old}^{s} ( {a}^{s} \vert {τ}^{s} ; {θ}_{old}^{s} )} .$$

The advantage function A^{π} is defined, but it is difficult to determine an individual contribution degree of each agent. In order to facilitate credit allocation, the joint advantage function may be decomposed as follows.

$${A}^{π} ( s , a ) = {\sum }_{i = 1}^{N} {c}^{s} \cdot {A}^{s} ( s , ( {a}^{s} , {a}^{- s} ) )$$

Herein, A^{s}(s, (a^{s}, a^{-s}))=Q^{π}(s, (a^{s}, a^{-s}))− [symbol] [Q^{π}(s, (ã^{s}, a^{-s}))] represents a counter factual advantage, and cs represents a non-negative weight.

Due to non-negative decomposition of A^{π}, there is a monotonous connection between the global optimum and local optimum, and this means conversion of arg max_{θ}_{¹}_{, . . . ,θ}_{^{S}} into arg max_{θ}_{¹}, . . . , arg max_{θ}_{^{S}}. The optimization of Equation 26 may be changed to the following Equation 27 to maximize an individual target of each agent.

$$L ( {θ}^{s} ) = {𝔼}_{a \sim {π}_{old}} \{ min [ ( {\prod }_{j \neq s} {r}^{s} ) {A}^{s} , clip ( ( {\prod }_{j \neq s} {r}^{j} ) {r}^{s} , 1 - ϵ , 1 + ϵ ) {A}^{s} ] \} \qquad ( Equation 27 )$$

However, when each agent is completely independent throughout execution, the possibility of excessive variance is increased, so variance may increase exponentially depending on the number of agents. Accordingly, through a double clipping approach, Equation 27 may be corrected as the following Equation 28.

$$L ( {θ}^{s} ) = {𝔼}_{a \sim {π}_{old}} \{ min [ ℊ ( {r}^{- s} ) {r}^{s} {A}^{s} , clip ( ℊ ( {r}^{- s} ) {r}^{s} , 1 - {ϵ}_{1} , 1 + {ϵ}_{1} ) {A}^{s} ] \} \qquad ( Equation 28 )$$

Herein, it is that g(r^{-s})=clip(Π_{j≠s}r^{j}, 1−ϵ₂, 1+ϵ₂), ϵ_{2<ϵ1}. In Equation 27, the presence of Π_{j≠s}r^{j} affects the target of the agent due to the weight of Π_{j≠s}r^{j}. As a result of clipping for Π_{j≠s}r^{j}, the update effect of other agents on the agent s may be limited to [1−ϵ₂, 1+ϵ₂] and thus variation generated by other agents may be limited.

When parameters of the actor network are corrected, the sampled action is delivered to the critic network, and the critic network estimates the estimated value of the action. Based on the predicted value, using a policy gradient approach polity, the actor may be changed. The expected value of the advantage function A^{π}^{^{old}} in the training step using a preserved sample may be estimated. In other words, the policy may be updated as the following Equation 29 using a gradient.

$${△θ}_{s} = {▽}_{{θ}_{s}} \hat{𝔼} [ min [ ℊ ( {r}^{- s} ) {r}^{s} {A}^{s} , clip ( ℊ ( {r}^{- s} ) {r}^{s} , 1 - {ϵ}_{1} , 1 + {ϵ}_{1} ) {A}^{s} ] \} \qquad ( Equation 29 )$$

Herein, A^{s} is generalized advantage estimation (GAE), and this may be defined by the following Equation 30.

$${A}^{s} ( s ( t ) , a ( t ) ) = \hat{Q} ( {s}^{′} ( t ) , a ( t ) ) - {V}_{{τ}_{s}^{old}} ( {s}^{′} ( t ) ) \qquad ( Equation 30 )$$

Herein, \hat{Q}^{s}(s′(t), a(t)) may be estimated by the following Equation 31 using a k-step bootstrapping linear combination.

$$\hat{Q} ( {s}^{′} ( t ) , a ( t ) ) ) = {\sum }_{k = t}^{∞} {( Ξ v )}^{k - t} δ ( t ) + {Q}_{{σ}_{s}^{old}} ( s ( t ) , a ( t ) ) \qquad ( Equation 31 )$$

Herein, δ(t) is a temporal difference, and this may be defined by Equation 32.

$$δ ( t ) = r ( t ) + {ΞQ}_{{σ}_{s}} ( {s}^{′} ( t + 1 ) , a ( t + 1 ) ) - {Q}_{{σ}_{s}^{old}} ( {s}^{′} ( t ) , a ( t ) ) \qquad ( Equation 32 )$$

Since each satellite estimates the same combined action-state value function, the loss function of the value network may be expressed by the following Equation 33, and to minimize such a loss function, the value network may be learned.

$${L}^{value} ( t , {σ}_{s} ) = {( \hat{Q} ( {s}^{′} ( t ) , a ( t ) ) - {Q}_{{σ}_{s}^{old}} ( {s}^{′} ( t ) , a ( t ) ) )}^{2} \qquad ( Equation 33 )$$

For this, a gradient descent method may be used, and the gradient value of each satellite (agent) may be calculated by the following Equation 34.

$${△σ}_{s} = {▽}_{{σ}_{s}} \hat{𝔼} [ {( \hat{Q} ( {s}^{′} ( t ) , a ( t ) ) - {Q}_{{σ}_{s}^{old}} ( {s}^{′} ( t ) , a ( t ) ) )}^{2} ] \qquad ( Equation 34 )$$

Herein, the parameters θ and σ may be changed until the loss function n of the policy network and value network converge, according to Equation 29 and Equation 34, respectively.

According to the example disclosed, by optimizing the satellite power, the association matrix between the RIS panel of the satellite and remote user terminal, phase shift of the RIS panel of the satellite, and elevation angle of the satellite, the data rate according to the reception signal of the remote user terminal can be maximized, and the coverage of each low earth orbit satellite can be optimized.

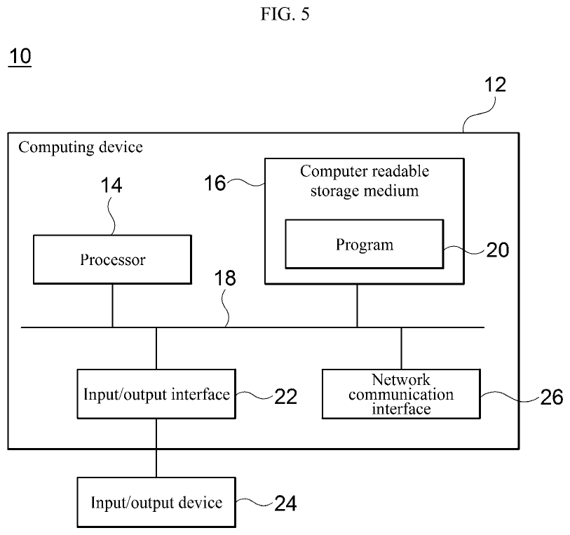

FIG. 5 is a block diagram for illustrating and explaining a computing environment (10) including a computing device suitable for use in exemplary examples. In the illustrated example, each component may have different functions and ability other than those described below, and may include an additional component other than those described below.

The illustrated computing environment (10) includes a computing device (12). In one example, the computing device (12) may be the remote user terminal (104). In addition, the computing device (12) may be the base station device (106). Furthermore, the computing device (12) may be a server computing device installed with a multi agent reinforcement learning model.

The computing device (12) includes at least one processor (14), a computer readable storage medium (16) and a communication bus (18). The processor (14) may allow the computing device (12) to operate according to the exemplary example mentioned above. For example, the processor (14) may execute at least one program stored in the computer readable storage medium (16). The at least one program may include at least one computer executable instruction, and the computer executable instruction may be composed to allow the computing device (12) to perform operations according to the exemplary example, when executed by the processor (14).

The computer readable storage medium (16) is composed to store computer executable instructions or program codes, program data and/or other appropriate forms of information. A program (20) stored in the computer readable storage medium (16) includes a set of executable instructions by the processor (14). In one example, the computer readable storage medium (16) may be a memory (volatile memory such as random access memory, non-volatile memory, or a suitable combination thereof), at least one magnetic disk storage device, optical disk storage devices, flash memory devices, other forms of storage media which can be accessed by other computing device (12) and store desired information, or a suitable combination thereof.

The communication bus (18) interconnects various other components of the computing device (12) by including the processor (14) and computer readable storage medium (16).

The computing device (120) may also include at least one input/output interface (22) and at least one network communication interface (26) which provide interfaces for at least one input/output device (24). The input/output interface (22) and network communication interface (26) are connected to the communication bus (18). The input/output device (24) may be connected to other component of the computing device (12) through the input/output interface (22). The exemplary input/output device (24) may include a pointing device (mouse or trackpad, etc.), a keyboard, a touch input device (touchpad or touchscreen, etc.), a voice and sound input device, various kinds of input devices such as sensor devices and/or photographing devices, and/or an output device such as a display device, a printer, a speaker, and/or a network card. An exemplary input/output device (24) may be included inside the computing device (12) as one component consisting of the computing device (12), and may be connected with the computing device (12) with a separate device distinguished from the computing device (12).

Representative examples of the present invention are described in detail above, but those skilled in the art to which the present invention pertains will understand that various modifications can be made to the afore-mentioned examples within limits without departing from the scope of the present invention. Therefore, the scope of the present invention should not be limited to the examples described, and should be determined by not only claims described later but also equivalents to these claims.

1. A communication method of a communication system comprising a plurality of satellites equipped with an RIS (Reconfigurable Intelligent Surface) panel, a plurality of rate user terminals, and at least one base station device, the communication method performed in a computing device equipped with one or more processors, and a memory storing one or more programs executed by the one or more processors, the communication method comprising:
calculating a reception signal of a remote user terminal, when the remote user terminal receives a signal transmitted from a satellite;
calculating a data rate of the remote user terminal using an SNR (Signal to Noise Ratio) of the corresponding user terminal for the reception signal; and
optimizing pre-set parameters to maximize the data rate of the remote user terminal.

2. The communication method according to claim 1,
wherein the reception signal (yᵤ) is calculated by the following equation:
$${y}_{u} = \sqrt{\frac{{p}_{u}}{{L}^{tot}}} {g}_{u}^{T} {{\prod }_{}}_{r = 1 , … , {R}_{s}} {Φ}_{r} {H}_{r} x + {z}_{u} \qquad ( Equation )$$
wherein L^{tot}: Total loss until signals are received by the remote user terminal;
pᵤ: Transmission power of the base station device;
gᵤ: Channel from last RIS panel to the remote user terminal;
x: Transmission vector of the base station device;
Rₛ: Total number of RIS panels;
zᵤ: AWGN (Additive White Gaussian Noise) received by the remote user terminal; and
r: Index of RIS.
Hᵣ: Channel matrix between the base station device and RIS panel r
Φᵣ: Phase shift of RIS panel r

3. The communication method according to claim 2,
wherein the SNR (Signal to Noise Ratio) at time slot t (Γ_{u,t}) of the remote user terminal is calculated by the following equation:
$${Γ}_{u , t} = \frac{{p}_{s , u} {\vert {v}_{b , u}^{s} {g}_{u}^{T} ( t ) {\prod }_{r = 1 , … , {R}_{s}} {Φ}_{r} {H}_{r} ( t ) {w}_{u} \vert}^{2}}{{N}_{o} {L}^{tot} ( f , d )} \qquad ( Equation )$$
wherein p_{s,u}: Power for transmitting signals from the satellite to the remote user terminal;
$${v}_{b , u}^{s} :$$
Element of association matrix for the remote user terminal;
N₀: Noise spectrum density; and
wᵤ: Beamforming vector of the base station device.

4. The communication method according to claim 3,
wherein the data rate (R_{u,t}) of the remote user terminal is calculated by the following equation:
$${R}_{u , t} = {B}_{u} {log}_{2} ( 1 + {Γ}_{u , t} ) \qquad ( Equation )$$
wherein Bᵤ: Total bandwidth available to the remote user terminal.

5. The communication method according to claim 1,
wherein the optimizing pre-set parameters, optimizes power (p) for transmitting a signal to a remote user terminal, an association matrix (V) between an RIS panel of a satellite and a remote user terminal, a phase shift (Φ) of the RIS panel of the satellite, and an elevation angle (α) of the satellite, to satisfy the objective function of the following equation:
$${max}_{p , V , Φ , α} {\sum }_{u = 1}^{U} {\sum }_{t = 1}^{T} {R}_{u , t} \qquad ( Equation )$$
wherein R_{u,t}: Data rate of the remote user terminal u at time slot t;
T: Total number of time slots; and
U: Total number of remote user terminals.

6. The communication method according to claim 5,
wherein the optimizing pre-set parameters comprises a first optimization step that optimizes the power (p) using a pre-set first algorithm after initiating the association matrix (V) between the RIS panel and remote user terminal, phase shift (Φ) of the RIS panel, and the elevation angle (α) of the satellite; and
a second optimization step that optimizes the association matrix (V) between the RIS panel and remote user terminal, phase shift (Φ) of the RIS panel, and the elevation angle (α) of the satellite through a pre-set second algorithm based on the optimized power (p).

7. The communication method according to claim 6,
wherein the first algorithm is a WOA (Whale Optimization Algorithm), and
the first optimization step, calculates an optimal value of the power (p) through a fitness function by the following equation:
$$Fitness ( Φ ) = - {\sum }_{u = 1}^{U} {\sum }_{t = 1}^{T} \{ {R}_{u , t} ( Φ ) + μ {F}_{u , t} ( {f}_{u , t} ( Φ ) ) {f}_{u , t}^{2} ( Φ ) \} \qquad ( Equation )$$
wherein ƒ_{u,t}(Φ): Inequality function;
μ: Pre-set constant; and
F_{u,t}(ƒ_{u,t}(Φ)): Index function.
The index function has a value of 0 when the inequality function is 0, and a value of 1 when the inequality function is less than 0.

8. The communication method according to claim 6,
wherein the second algorithm is an algorithm using a multi agent reinforcement learning model, and
the second algorithm optimizes the association matrix (V) between the RIS panel and remote user terminal, phase shift (Φ) of the RIS panel, and the elevation angle (α) of the satellite to satisfy an objective function of the following equation:
$${max}_{V , Φ , α} {\sum }_{u = 1}^{U} {\sum }_{t = 1}^{T} {R}_{u , t} . \qquad ( Equation )$$

9. The communication method according to claim 8,
wherein the second optimization step comprises inputting the global state (s′) of the plurality of satellites and the local state (s′ₛ) of each satellite according to the following equation to the multi agent reinforcement learning model:
$${s}^{′} = \{ \{ {d}_{1} \} , \{ {V}_{1} \} , \{ {Φ}_{1} \} , \{ {p}_{1}^{*} \} , \{ {i}_{1} , {ω}_{1} , {ϰ}_{1} \} \} , \text{} … , \{ {d}_{s} \} , \{ {V}_{s} \} , \{ {Φ}_{s} \} , \{ {p}_{s}^{*} \} , \{ \{ {i}_{s} , {ω}_{s} , {ϰ}_{s} \} \} \qquad ( Equation )$$
$${s}_{s}^{′} = \{ \{ {d}_{s} \} , \{ {V}_{s} \} , \{ {Φ}_{s} \} , \{ {p}_{s}^{*} \} , \{ {i}_{s} \} , \{ {ω}_{s} \} , \{ {ϰ}_{s} \} \}$$
wherein dₛ: Location of satellite s;
Vₛ: Association matrix between the RIS panel and the user terminal of satellite s;
Φₛ: Phase shift of the RIS panel of the satellite s;
p*ₛ: Optimized power of the satellite s;
iₛ: Intersection angle between the orbital plane and equator of satellite s;
ωₛ: Angle between the vernal equinox point and the intersection point of orbital plane and equatorial plane of satellite s; and
χₛ: Angle formed by the direction of the satellite and the intersection point of orbital plane and equatorial plane of the satellite s.

10. The communication method according to claim 9,
wherein the second optimization step, comprises:
calculating an action for an association between the RIS panel and user terminal, a phase shift of the RIS panel, and an elevation angle of the phase, based on the local state of each satellite in the multi agent reinforcement learning; and
giving a global reward for the calculated action in the multi agent reinforcement learning model to the plurality of satellites.

11. The communication method according to claim 10,
wherein the second optimization step further comprises learning the multi agent reinforcement learning model so that the global reward (R_{s′,t}) by the following equation is Maximized:
$$( Equation )$$
$${R}_{{s}^{′} , t} = {R}_{t} ( {s}_{t ,}^{′} {a}_{t} ) = \{ \begin{matrix}{\sum }_{u = 1}^{U} {\sum }_{t = 1}^{T} {R}_{u , t} , if all the associated RUEs is served by networks , \\ - {Γ}^{pen} , otherwise impose penalty to perform better in learning .\end{matrix}$$
wherein sₜ′: Local state of the satellite at time slot t;
aₜ: Action of the satellite at time slot t;
RUE: Remote user terminal; and
−Γ^{pen}: Penalty value.

12. A computing device for performing a communication method of a communication system comprising a plurality of satellites equipped with an RIS (Reconfigurable Intelligent Surface) panel, a plurality of rate user terminals, and at least one base station device, the computing device comprising:
one or more processors;
a memory; and
one or more programs stored in the memory and executed by the one or more processors,
wherein the one or more programs, comprising:
an instruction for calculating a reception signal of a remote user terminal, when the remote user terminal receives a signal transmitted from a satellite;
an instruction for calculating a data rate of the remote user terminal using an SNR (Signal to Noise Ratio) of the corresponding user terminal for the reception signal; and
an instruction for optimizing pre-set parameters to maximize the data rate of the remote user terminal.

13. The computing device according to claim 12,
wherein the instruction for optimizing pre-set parameters optimizes power (p) for transmitting a signal to a remote user terminal, an association matrix (v) between an RIS panel of a satellite and a remote user terminal, a phase shift (Φ) of the RIS panel of the satellite, and an elevation angle (α) of the satellite, to satisfy the objective function of the following equation:
$${max}_{p , V , Φ , α} {\sum }_{u = 1}^{U} {\sum }_{t = 1}^{T} {R}_{u , t} \qquad ( Equation )$$
wherein R_{u,t}: Data rate of the remote user terminal u at time slot t;
T: Total number of time slots; and
U: Total number of remote user terminals.

14. The computing device according to claim 13,
wherein the instruction for optimizing pre-set parameters, comprises:
a first optimization instruction that optimizes the power (p) using a pre-set first algorithm after initiating the association matrix (V) between the RIS panel and remote user terminal, phase shift (Φ) of the RIS panel, and the elevation angle (α) of the satellite; and
a second optimization instruction that optimizes the association matrix (between the RIS panel and remote user terminal, phase shift (Φ) of the RIS panel, and the elevation angle (α) of the satellite through a pre-set second algorithm based on the optimized power (p).

15. The computing device according to claim 14,
wherein the first algorithm is a WOA (Whale Optimization Algorithm), and
the first optimization instruction calculates an optimal value of the power (p) through a fitness function by the following equation:
$$Fitness ( Φ ) = - {\sum }_{u = 1}^{U} {\sum }_{t = 1}^{T} \{ {R}_{u , t} ( Φ ) + μ {F}_{u , t} ( {f}_{u , t} ( Φ ) ) {f}_{u , t}^{2} ( Φ ) \} \qquad ( Equation )$$
wherein ƒ_{u,t}(Φ): Inequality function;
μ: Pre-set constant; and
F_{u,t}(ƒ_{u,t}(Φ)): Index function;
wherein the index function has a value of 0 when the inequality function is 0, and a value of 1 when the inequality function is less than 0.

16. The computing device according to claim 14,
wherein the second algorithm is an algorithm using a multi agent reinforcement learning model, and
the second algorithm optimizes the association matrix (V) between the RIS panel and remote user terminal, phase shift (Φ) of the RIS panel, and the elevation angle (α) of the satellite to satisfy an objective function of the following equation:
$${max}_{V , Φ , α} {\sum }_{u = 1}^{U} {\sum }_{t = 1}^{T} {R}_{u , t} . \qquad ( Equation )$$

17. The computing device according to claim 16,
wherein the second optimization instruction; comprises an instruction for inputting the global state (s′) of the plurality of satellites and the local state (s′ₛ) of each satellite according to the following equation to the multi agent reinforcement learning Model:
$${s}^{′} = \{ \{ {d}_{1} \} , \{ {V}_{1} \} , \{ {Φ}_{1} \} , \{ {p}_{1}^{*} \} , \{ {i}_{1} , {ω}_{1} , {ϰ}_{1} \} \} , \text{} … , \{ {d}_{s} \} , \{ {V}_{s} \} , \{ {Φ}_{s} \} , \{ {p}_{s}^{*} \} , \{ \{ {i}_{s} , {ω}_{s} , {ϰ}_{s} \} \} \qquad ( Equation )$$
$${s}_{s}^{′} = \{ \{ {d}_{s} \} , \{ {V}_{s} \} , \{ {Φ}_{s} \} , \{ {p}_{s}^{*} \} , \{ {i}_{s} \} , \{ {ω}_{s} \} , \{ {ϰ}_{s} \} \}$$
wherein dₛ: Location of satellite s;
Vₛ: Association matrix between the RIS panel and the user terminal of satellite s;
Φₛ: Phase shift of the RIS panel of the satellite s;
p*ₛ: Optimized power of the satellite s;
iₛ: Intersection angle between the orbital plane and equator of the satellite s;
ωₛ: Angle between the vernal equinox point and the intersection point of orbital plane and equatorial plane of the satellite s; and
χₛ: Angle formed by the direction of the satellite and the intersection point of orbital plane and equatorial plane of the satellites.

18. The computing device according to claim 17,
wherein the second optimization instruction comprises:
an instruction for calculating an action for an association between the RIS panel and user terminal, a phase shift of the RIS panel, and an elevation angle of the phase, based on the local state of each satellite in the multi agent reinforcement learning; and
an instruction for giving a global reward for the calculated action in the multi agent reinforcement learning model to the plurality of satellites.

19. The computing device according to claim 18,
wherein the second optimization instruction, further comprises an instruction for learning the multi agent reinforcement learning model so that the global reward (R_{s′,t}) by the following equation is maximized:
$$( Equation )$$
$${R}_{{s}^{′} , t} = {R}_{t} ( {s}_{t ,}^{′} {a}_{t} ) = \{ \begin{matrix}{\sum }_{u = 1}^{U} {\sum }_{t = 1}^{T} {R}_{u , t} , if all the associated RUEs is served by networks , \\ - {Γ}^{pen} , otherwise impose penalty to perform better in learning .\end{matrix}$$
wherein sₜ′: Local state of the satellite at time slot t;
aₜ: Action of the satellite at time slot t
RUE: Remote user terminal
−Γ^{pen}: Penalty value.

20. A computer program stored in a non-transitory computer readable storage medium, the computer program comprising:
instructions for performing a communication method of a communication system comprising a plurality of satellites equipped with an RIS (Reconfigurable Intelligent Surface) panel, a plurality of rate user terminals, and at least one base station device,
wherein the instructions, when executed by a computing device having one or more processors, make the computing device to perform:
calculating a reception signal of a remote user terminal, when the remote user terminal receives a signal transmitted from a satellite;
calculating a data rate of the remote user terminal using an SNR (Signal to Noise Ratio) of the corresponding user terminal for the reception signal; and
optimizing pre-set parameters to maximize the data rate of the remote user terminal.
